(19) United States
(12) Patent Application Publication
(10) Pub. No.: US 2024/0103143 A1
(43) Pub. Date: Mar. 28, 2024

(54) FALSE TARGET DETECTION USING QUANTUM DECOHERENCE

(71) Applicant: RAYTHEON COMPANY, Waltham, MA (US)

(72) Inventors: Sebastian Chiaramida, Stoneham, MA (US); Peter Barry Morris, Derry, NH (US)

(21) Appl. No.: 17/946,980

(22) Filed: Sep. 16, 2022

(51) Int. Cl. G01S 7/487; G01S 7/48; G01S 7/483; G01S 17/58

(52) U.S. Cl. CPC G01S 7/4873; G01S 7/4802; G01S 7/4808; G01S 7/483; G01S 17/58

(57) ABSTRACT

False radar target detection incudes: generating a pair of entangled photons as a probe photons and idler photons; preparing a plurality of photon states; using the ancilla photon states to encode the probe photons and the idler photons; encoding the probe photons and the idler photons with the ancilla photon states; storing the idler photons; transmitting the probe and ancilla photons as a radar signal; receiving a return radar signal from the target; performing a quantum error detection on the return radar signal to determine whether there is an error in the received radar signal as a result of decoherence in the return signal; and correlating the probe signal, the idler states and analyzing the errors detected on the return radar signal to determine whether the target is a true target when there is low decoherence in the return radar signal.

### FIELD OF THE INVENTION

The present disclosure generally relates to target detection using quantum sensing and more particularly to false radar target detection using the phenomenon of quantum decoherence (partial loss of entanglement).

### BACKGROUND

When a radar is conducting surveillance in a region, the radar transmits a probe signal and receives a return signal from a target. If the target is a real (passive) object of interest, the return signal is simply a signal reflected from the target. However, if a return signal is the result of special processing by an adversary, the radar algorithms may interpret the return as true rather than as a false detection.

Typically, a conventional radar processor attempts to distinguish between a false target and a real one by using “reasonableness tests”, one of which involves the detected range, together with a detection threshold. However, there are instances when those reasonableness tests will fail.

Therefore, there is a need for an improved false target detection approach that improves the identification of real and false targets and determines whether the return radar signal is a true reflection of the radar probe signal from an asset-of-interest.

### SUMMARY

In some embodiments, the disclosure is directed to a method and system for false target detection using quantum decoherence and quantum error detection, where a quantum sensor compares the return radar signal to its entangled “twin” signal, that is, an idler signal at the source of transmission. This comparison determines the amount of decoherence of the return signal to estimate whether the target is real or false. A false target signal exhibits a large amount of decoherence, where a real reflected signal exhibits a relatively smaller amount of decoherence.

In some embodiments, the present disclosure describes a method for false radar target detection. The method includes receiving target information from a target detection source; generating pairs of entangled probe and idler photons; preparing a plurality of photon states to generate ancilla photon states for each of the probe photon pair and the idler photon pair; using the ancilla photon states to encode the probe photons and the idler photons; encoding the probe photons and the idler photons with the ancilla photon state; storing the idler photons; transmitting the probe and ancilla photons as a radar signal towards a target, using the received target information; receiving a return radar signal from the target, where the received radar signal includes the probe photons and the ancilla photon states for the probe photons; performing a quantum error detection on the return radar signal to determine whether there is an error in the received radar signal as a result of decoherence in the return signal; and correlating the probe signal and idler states and detecting the errors in the return radar signal to indicate the target as a false target when there is high decoherence in the return radar signal, or to indicate the target as a true target when there is low decoherence in the return radar signal.

In some embodiments, the present disclosure describes a quantum sensor for false radar target detection. The quantum sensor includes a transmitter including: one or more photon sources for generating pairs of entangled photons as probe photons and idler photons, a photon state preparer for preparing a plurality of photon states to generate an ancilla photon state for each of the probe photon pair and the idler photon pair, a photon encoder for encoding the probe photons and the idler photons and encoding the probe photons and the idler photons with the ancilla photon states, and an energy storage device for storing the idler photons, wherein the transmitter transmits the probe and ancilla photons as a radar signal towards a target.

The quantum sensor also includes a receiver including: a photon receiver for receiving a return radar signal from the target and detecting the entangled probe photons that are entangled with the ancilla states of the probe photons in the return signal, where the received radar signal includes the probe photons and the ancilla photon states for the probe photons, and a quantum signal processor for performing a quantum error detection on the received radar signal to determine whether there is an error in the received radar signal. A processor correlates the probe signal, the idler states and the errors detected on the return radar signal to indicate the target as a false target when there is high decoherence in the return radar signal, or to indicate the target as a true target when there is low decoherence in the return radar signal.

In some embodiments, the decoherence in the return signal is compared with a predetermined threshold, where decoherence greater than or equal to the predetermined threshold is associated with a false target and decoherence less than the predetermined threshold is associated with a true target. In some embodiments, the error is evaluated to determine decoherence in the received radar signal; and a degree of entanglement measure is computed based on the number and distribution of the errors; and the target is determined as a false target when the error exceeds a threshold.

### BRIEF DESCRIPTION OF THE DRAWINGS

The components in the figures are not necessarily to scale, emphasis instead being placed upon illustrating the principles of the disclosure. Like reference numerals designate corresponding parts throughout the different views. Embodiments are illustrated by way of example and not limitation in the figures of the accompanying drawings, in which:

FIG. 1 illustrates a block diagram of a radar system for false target detection using quantum decoherence, according to some embodiments of the present disclosure.

FIG. 2 is an exemplary block diagram of a quantum radar/sensor, according to some embodiments of the present disclosure.

FIG. 3 shows a plot of correlation as a function of degree of entanglement, according to some embodiments of the present disclosure.

FIG. 4 is an exemplary block diagram for transmit signal preparation and

return signal processing, according to some embodiments of the present disclosure.

FIG. 5 is an exemplary block diagram for a quantum radar/sensor, according to some embodiments of the present disclosure.

FIG. 6 illustrates a simplified process flow for quantum signal processor, according to some embodiments of the disclosure.

### DETAIL DESCRIPTION

In some embodiments, the present disclosure utilizes the concept of decoherence and applies it to distinguish a false sensor target from a real one. In some embodiments, quantum error detection coding is used to estimate the noise/errors associated with decoherence of returned sensor signals. In some embodiments, a model of the probe/idler photon states that includes partial entanglement, i.e., partial decoherence of the original fully entangled signal/idler state is used. Partial decoherence methodology coupled with quantum error detection coding is applied to determine the errors contributing to the decoherence of the return signal to discriminate real targets from false targets.

In some embodiments, a sensor transmit signal is produced with photon states distributed (encoded) across redundant photons with pre-determined states (e.g., ancilla photon states). The transmit signal is transmitted in the direction of a desired target. The return signal (with encoded photons) is then processed with photons of pre-determined states to detect the amount of noise and decoherence. A real reflected return signal exhibits a relatively small amount of decoherence (less than a predetermined threshold). This approach demonstrates lower probe signal decoherence for a real target than that for a false target. The preparation of transmit signal and return signal processing allows for discrimination of a real target versus a false target.

In some embodiments, the present disclosure may include a classical (conventional) radar system that transmits a pulse, measures the return pulse reflected from a target indicating the presence of the target and information about the target, such as location, range, orientation and velocity as well as signal information, such as frequency, pulse width, pulse repetition frequency, and polarization. In some embodiments, the classical radar cues a quantum-based radar (sensor) that generates a pair of entangled probe photons, a pair of entangled idler photons (four-wave mixing) and also generates ancilla photon states. It then uses the entangled probe photon state in as a transmit signal and sends the transmit signal towards the target (based on the target information received from classical radar) and then performs a quantum error detection on the return signal to determine whether there is an error and the degree of decoherence in the return signal.

As known in the art, quantum entanglement of photons is the physical phenomenon that occurs when a group of photons are generated, interact, or share spatial proximity in a way such that the quantum state of each photon in the group cannot be described independently of the state of the others, including when the particles are separated by a large distance. However, in a quantum algorithm there is no way to deterministically put bits in a specific prescribed state unless one is given access to bits whose original state is known in advance. Such bits, whose values are known a priori, are known as ancilla bits in a quantum computing task. Accordingly, by generating a pair of entangled photons and preparing a plurality of photon states to generate ancilla photon states, the quantum-based radar (sensor) is able to determine whether there is an error in the received radar signal as a result of decoherence using the prepared photon states as part of the Quantum Error Detection Methodology.

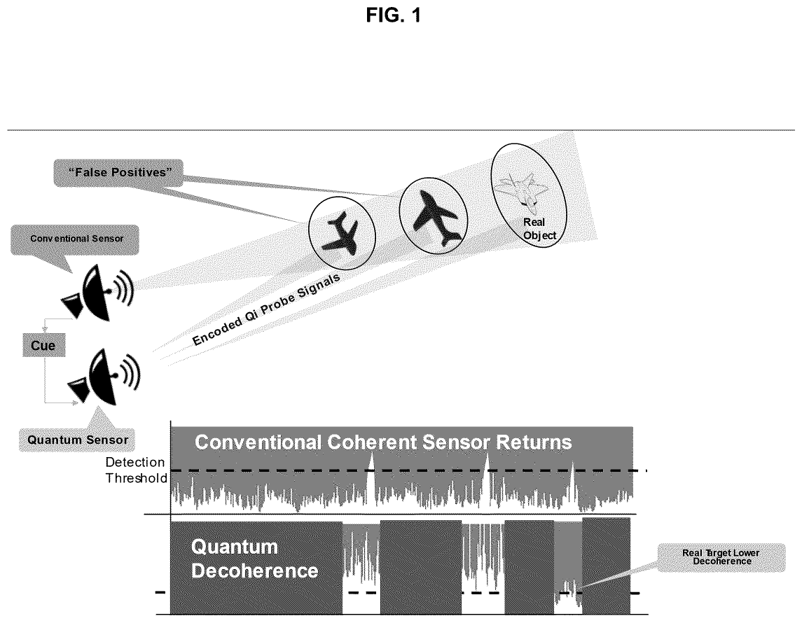

FIG. 1 illustrates a block diagram of a radar system for false target detection using quantum decoherence, according to some embodiments of the present disclosure. As shown a classical radar/sensor transmits a radar signal towards an object. In this example, the classical radar/sensor detects three objects within its main beam, only one of which is a real target/object. The classical radar/sensor cues a quantum radar/sensor by communicating with the quantum radar/sensor. The quantum radar/sensor uses the target information (e.g., location, orientation, velocity, trajectory, and the signal structure data) and emits a (second) transmit signal towards the target. The (second) transmit signal may be an optical signal or microwave electro-magnetic (EM) pulse, such as a pulsed microwave signal. The classical radar/sensor sends timing information to the quantum radar/sensor to activate the transmission of the (second) transmit signal at a certain time and estimate when the return signal is expected back to the quantum radar/sensor receiver if a true target is located where the classical radar has identified a detection. The two radars/sensors are also capable of exchanging data, such as commands and target information.

In some embodiments, the quantum sensor compares (e.g., using quantum error detection and correlation) the return optical signal to its entangled “twin,” that is, the idler signal at the quantum sensor. This comparison determines the amount of noise and decoherence of the return signal to estimate whether the target is real or false. In some embodiments, the quantum sensor then uses quantum error detection coding and previously developed measures of decoherence to detect the amount of decoherence. This approach improves the measurement of decoherence, which allows discrimination of real and false targets. In some embodiments, the quantum sensor uses decoherence calculations to detect the amount of decoherence. A false target signal exhibits a large amount (more than a predetermined threshold) of decoherence, as shown in the lower plot of FIG. 1. A real reflected signal exhibits a relatively small amount of decoherence (less than a predetermined threshold). The approach is superior to a single photon detection/correlation approach, and conventional correlation approaches.

More specifically, the quantum sensor generates several (e.g., a pair of) entangled photons as a probe and idler photons and generates prepared ancilla photon states. The quantum sensor then uses the ancilla photon states to encode the probe photons and idler photons and transmits the probe photons as a radar signal. The (encoded) transmit radar signal is then transmitted towards the target, using the target information from the classical radar/sensor. The return radar signal includes the photon ancilla states and the entangled probe photons. The quantum sensor then performs a quantum error detection on the received radar signal to determine whether there is an error in the received radar signal as a result of decoherence, using the prepared photon ancilla states. When there are errors in the received radar signal that indicate large amount of decoherence, the target is identified as a false target.

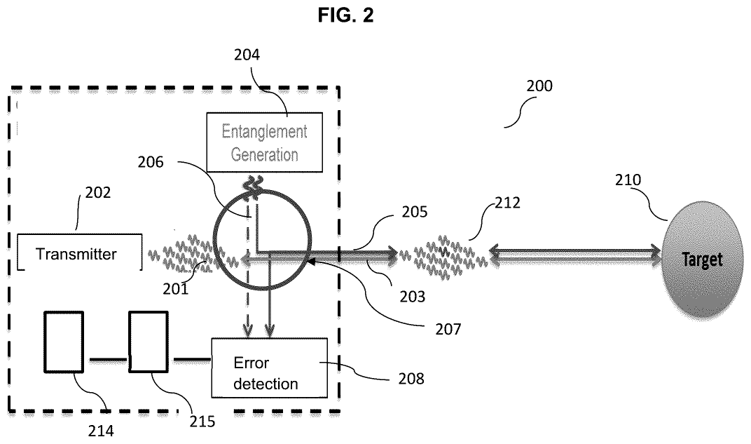

FIG. 2 is an exemplary block diagram of a quantum radar/sensor 200, according to some embodiments of the present disclosure. As shown, a transmitter 202 transmits an optical signal or electro-magnetic (EM) pulse 201 towards a target 210. The quantum radar/sensor 200 may include a (classical) processor with associated circuitry and memory 214 for encoding the transmit signals and processing the return signals for determining whether the return signal is from a true target or from a false target. Alternatively, or in combination, the processor (or a portion of the processing functions) may be outside of the quantum sensor. The encoded transmit signal is reflected from target 210 and is then measured for amount of error and decoherence indicating the presence of a true or false target. Photon states are prepared to serve as ancilla photons and a quantum entangled pair (state) of photons is generated by an entanglement generation module/device 204. Photon states may be described by the photon's polarization, frequency, linear momentum, wave number, wavelength, and the like. The quantum entangled state comprises entangled probe photons 205 and entangled idler photons 206. The entangled probe photon 205 is encoded (combined) with an entangled prepared ancilla photon 203 by an encoder and sent towards the target 210 by the transmitter 202. Some examples of sources of entangled photons include spontaneous parametric downconverters (SPDC) using nonlinear crystals in the optical domain, or Josephson Parametric Converters in the microwave domain.

The entangled idler photons 206 and the prepared photon states are stored in a quantum memory 215 for later access by the quantum error detection module 208. The return signal includes the entangled probe photons 205 and the prepared photon states, and some noise 212 resulting from decoherence. To validate the veracity of the return signal, the return signal is processed in the quantum error detection module 208, to detect whether there is an error in the received radar signal as a result of loss of decoherence, utilizing the prepared photon states and the (stored) entangled idler photons accessed from the quantum memory 215. When there are errors in the received radar signal that indicates loss of decoherence, for example, when the amount of decoherence is greater than a predetermined threshold value, the target is identified as a false target and the radar system (of FIG. 1) attempts to search for a “real” return pulse from a real target.

In some embodiments, rather than focusing on quantum states that are either fully entangled or fully factorizable (separable), the disclosure considers photon states that are partially entangled, that is, states that have an entangled component and a factorizable component. Initially, the (entangled) probe and idler photons are in a fully entangled state. Upon traversing the path to the target, the (entangled) probe photons are still entangled with the idler photons but now combined with a thermal noise state. The noise photons are not necessarily entangled with the probe/idler photons, but the noise states are “multiplied by” the entangled signal/idler state. When returning from the target, the probe entangled state undergoes some decoherence so that the resulting state is a linear combination of an entangled component state ((signal+idler)⊗noise) and a factorizable component state (signal⊗idler⊗noise). In general, the original state is said to have suffered partial decoherence.

Assuming that the entangled component is given by:

|ψₑ [symbol] =|ψ [symbol] _{SI}|ψ [symbol] _{B}=Σₙ₌₀^{∞}αₙ|n [symbol] _{S}|n [symbol] _{I}|m [symbol] _{B}

where

$$\\ {α}_{n} = \frac{1}{\sqrt{{n}_{S} + 1}} \sqrt{{( \frac{{n}_{S}}{{n}_{S} + 1} )}^{n}} ;$$

the factorizable component is assumed to be given by

|ψ_{f} [symbol] =|n [symbol] _{S}|n [symbol] _{I}|m [symbol] _{B}

With p as a function of average noise, the correlation function C_{IR} becomes

$$\\ {C}_{IR} = \frac{\sqrt{η {n}_{S} ( {n}_{S} + 1 )}}{B + 1} \pm \frac{\sqrt{B}}{B + 1} \sqrt{( \frac{η}{{n}_{S} + 1} )} [ {e}^{i ϕ} ( {N}_{S} + 1 ) \sqrt{{β}^{{N}_{S} + 1}} + {e}^{- i ϕ} {N}_{S} \sqrt{{β}^{{N}_{S} - 1}} ] {δ}_{{N}_{B} , {M}_{B}}$$

It is observed from the above that the second term (in brackets) vanishes for NB≠MB. Thus, the correlation is smaller for NB≠MB and therefore larger for NB=MB. This seems intuitively correct since, that is, if the noise associated with the entangled state is the same as that associated with the factorizable state, then the correlation of the target return photons with the idler photons will be higher. On the other hand, if the noise is different, the correlation will be lower. The quantity p is a measure of entanglement, so that when p is higher, entanglement is greater and thus decoherence is lower. Note also that C_{IR} is larger when the reflectivity, η is higher, as expected. Also, the correlation decreases with increasing B.

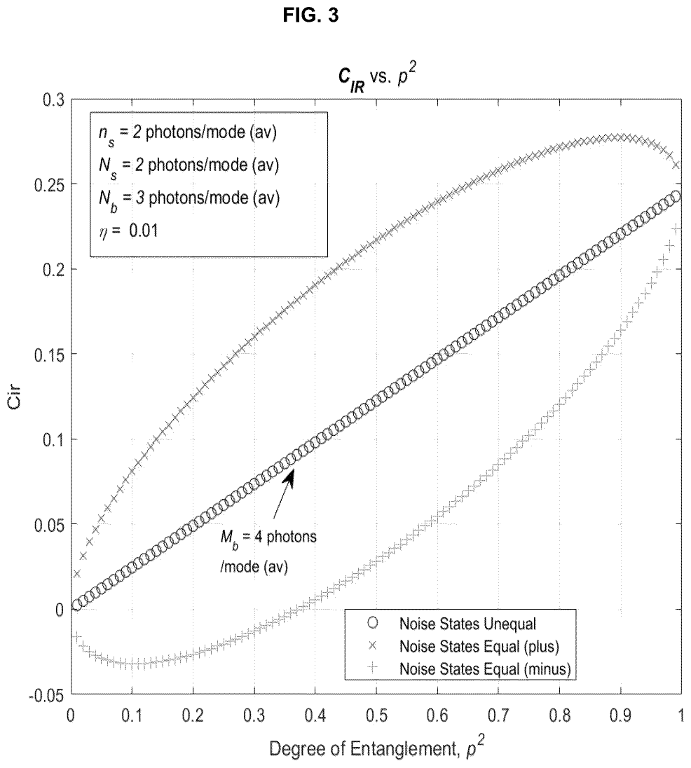

FIG. 3 shows a plot of correlation as a function of degree of entanglement, p², according to some embodiments of the present disclosure. This plot is C_{IR} vs. degree of entanglement, p², before p is set to be inversely proportional to ±the square root of B+1.

Because of the asymptotic nature of the C_{IR} curves, the difference between the C_{IR} values for the false target and real target may be less than a discrimination threshold. Accordingly, a supplementary method of determining decoherence is developed using quantum error correction.

Quantum error correction (QEC) has been used in quantum computing to protect quantum information from errors due to decoherence and other quantum noise to achieve fault-tolerant quantum computation that can reduce the effects of noise on stored quantum information. Recently developed theories in Quantum Gravity suggest that the analytics of entanglement and quantum error detection/correction coding are closely related. The present disclosure uses quantum error detection coding with a process where a transmitted signal is prepared (encoded) with entangled redundant states to estimate the noise/errors associated with decoherence of returned sensor signals. In other words, the received signal is measured to determine if the original signal content was changed during transmission. Quantum error detection coding combined with partial decoherence methodology determines the errors contributing to the loss of decoherence of the return signal to discriminate real targets from false targets.

Basic principle of error correction, both in classical and in quantum domains, adds redundant bits used to encode a given amount of information. Classically, bits are either “0” or “1”, but, in the quantum world of entangled bits, qubits are written as |ψ [symbol] =α|0 [symbol] +β1 [symbol] (|α|²+|β|²=1) and can take on a continuum of values as given on the Bloch Sphere known in the art.

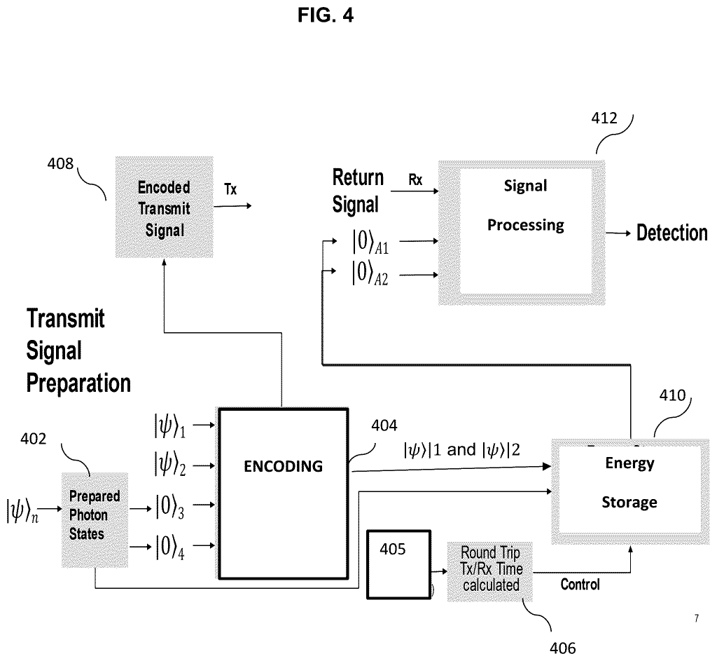

FIG. 4 is an exemplary block diagram for transmit signal preparation and return signal processing by a quantum radar/sensor, according to some embodiments of the present disclosure. For simplicity, two entangled photons (a signal probe photon and idler photon) are considered in this example. As shown in block 402, photons with definite states are prepared and input to a (quantum) encoding block 404 along with the signal probe and idler redundant entangled photons (having random (but entangled) states) |ψ [symbol] |1 and |ψ [symbol] |2. The photons with definite prepared states are used for encoding the entangled probe photon and idler. The information contained in the signal and idler photons is distributed (encoded) across the two redundant entangled photons with pre-determined states for the purpose of quantum redundancy in quantum error detection.

In some embodiments, a minimum-length code ([[n, k, d]], for example, [[4, 2, 2]]), that detects both bit-flip and phase-flip errors is used. In this example, n=4 is the total number of bits per codeword, k=2 is the number of encoded bits, d=2 is the distance of the code, i.e., the number of successive single-bit errors the codeword can sustain before becoming another codeword. The [[4,2,2]] detection code is the smallest stabilizer code that can detect quantum noise that is subject to both bit-flips and phase-flip errors. In some embodiments, the use of quantum error detection coding may require the use of four-wave mixing in the entanglement generation process to supply the redundant bits.

In some embodiments, the signal-input state could be written as

(α|00 [symbol] +β|11 [symbol] )_{A}

where α and β are complex coefficients. The two qubits in the state refer to the two signal probe photons obtained from four-wave mixing. A similar expression holds for the idler state where the two qubits refer to the two idler photons. Ideally, there are no mixed states in the transmit channel, although there may be in the receive channel. A target state of (|00 [symbol] )_{B} can be used to entangle the input state via a Controlled NOT (CNOT) gate. This target state can be obtained from four-wave mixing or non-entangled pump beam photons. This entanglement yields the coded state

α|0000 [symbol] +β|1111

[symbol]

The output of the encoder 404 incudes the entangled (probe and idler) photons |ψ [symbol] =α|0000 [symbol] +β|1111 [symbol] , each entangled with ancilla photon states. The encoded radar signal is then transmitted towards the object of interest by a transmitter 408. Another output of the encoder 404 is the set of entangled idler photon and ancilla photon states which is stored in an energy storage device 410 (e.g., a quantum memory) for comparison with the same information encoded in the return radar signal.

Target information (e.g., location, velocity, trajectory, and signal waveform data) and timing controls 405 are received from a classical radar/sensor. Transmit/receive signal round trip time is calculated (by a processor) in block 406. This timing information is used by the quantum radar/sensor to determine when to transmit the encoded transmit signal and when to start detecting the return signal.

When the return radar signal is received, it is decoded (e.g., by syndrome extraction) and correlated with the stored entangled idler photon and the ancilla photon states by a signal processor 412, (for example, a beam splitter) within the signal processor. A minimum-length detection code ([[n, k, d]], for example, [[4, 2, 2]]) is then used by the signal processor 412 to determine the relative noise level and decoherence in the return signal. In some embodiments, the relative noise level and decoherence is then compared to a predetermined threshold (that may be experimentally determined based on various required applications). Higher values of decoherence are associated with noisy/non-transmitted signal or false target, while lower values of decoherence are associated with a real target return.

In some embodiments, with the chosen general forms of |ψₑ [symbol] and |ψ [symbol] the correlation of the target return state with the idler state C_{IR} is calculated as

C_{IR}= [symbol] ψ|â_{I}^{†}â_{R}^{†}|ψ

[symbol]

which simplifies to:

C_{IR}=pT₁+\sqrt{1−p²}T₂

where T₁ and T₂ are functions of n_{S} (=n_{I}) and N_{S} (=N_{I}) which are the mean number of signal (idler) photons/mode in the entangled and factorizable components, respectively.

Since the decoherence of an entangled pair of photons is due to interaction with the environment, which can be characterized by noise, p is set to:

$$\\ {p}^{2} = \frac{1}{B + 1} p = \pm \frac{1}{\sqrt{B + 1}} ; where B = \frac{{N}_{B} + {M}_{B}}{2}$$

Here, B is the mean number of noise photons per mode, averaged over the noise photons/mode associated with the original entanglement and the noise photons/mode associated with the factorizable component.

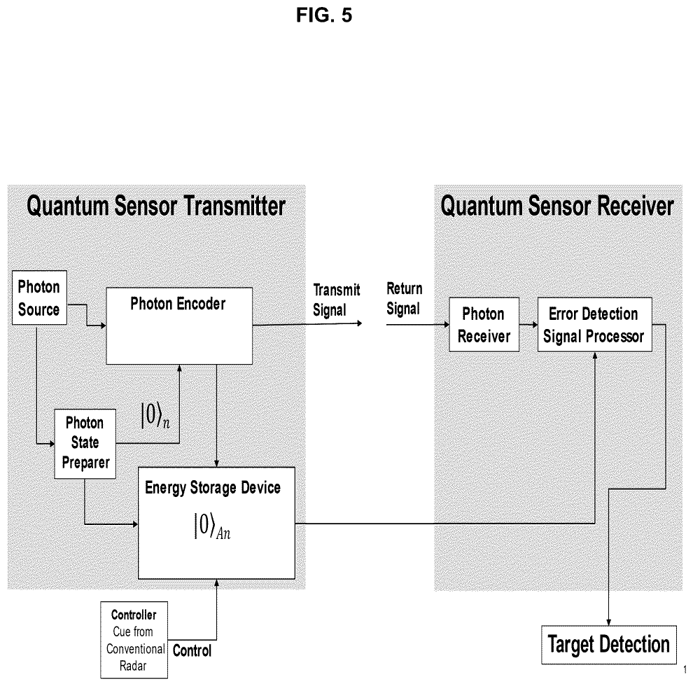

FIG. 5 is an exemplary block diagram for a quantum radar/sensor, according to some embodiments of the present disclosure. As depicted, the quantum radar/sensor includes a transmitter and a receiver. The transmitter includes a photon source (e.g., a laser pump and a non-linear crystal), a photon state preparer that eliminates mixed states or forces the states of the photon to a predetermined set (e.g., a polarizer intercepting a portion of the pump beam), a controller, an energy storage device (e.g., a quantum memory) and a photon encoder that expands the Hilbert space (e.g., a combination of C-NOT and Hadamard gates). The controller may be included in the quantum radar/sensor or outside of the quantum radar/sensor. An output of the photon source (a beam) is input to the photon state preparer. The photon source produces a pair of entangled probe photons and entangled idler photons. The photon state preparer produces the ancilla states for the entangled probe photons and entangled idler photons, using the beam output of the photon source, as described above with respect to FIG. 4. As mentioned above, a target state of (|00 [symbol] )_{B} can be used to entangle the input state via a Controlled NOT (CNOT) gates.

The photon encoder encodes the probe photons that are entangled with the ancilla states of the probe photon. The result is an encoded transmit signal, using the outputs of the photon state preparer and the photon source. The transmitter then transmits the encoded transmit signal towards a target. The idler photons that are entangled with the ancilla states of the idler photons are also stored in the energy storage device to be used for correlation with the return signal. A controller controls the timing and synchronization of the quantum radar/sensor based on controls from a classical radar/sensor.

The receiver of the quantum radar/sensor includes a photon receiver (e.g., a phase-conjugate receiver or a spontaneous parametric down-converter), and a quantum error detection signal processor. The photon detector receives the return radar signal and detects the entangled probe photons that are entangled with the ancilla states of the probe photons in the return signal and outputs them to the quantum signal processor. The quantum signal processor then performs a quantum error detection on the received radar signal to determine whether there is an error in the received radar signal. In other words, the quantum radar/sensor includes a transmitter including:

one or more photon sources for generating pairs of entangled photons as probe photons and idler photons, a photon state preparer for preparing a plurality of photon states to generate an ancilla photon state for each of the probe photon pair and the idler photon pair, a photon encoder for encoding the probe photons and the idler photons and encoding the probe photons and the idler photons with the ancilla photon states, and an energy storage device for storing the idler photons, wherein the transmitter transmits the probe and ancilla photons as a radar signal towards a target.

The quantum radar/sensor also includes a receiver including: a photon receiver for receiving a return radar signal from the target and detecting the entangled probe photons that are combined with the ancilla states of the probe photons in the return signal, where the received radar signal includes the probe photons and the ancilla photon states for the probe photons, a quantum signal processor for performing a quantum error detection on the received radar signal to determine whether there is an error in the received radar signal, wherein a processor correlates the probe and idler states and the errors detected on the return radar signal to indicate the target as a false target when there is high decoherence in the return radar signal, or to indicate the target as a true target when there is low decoherence in the return radar signal.

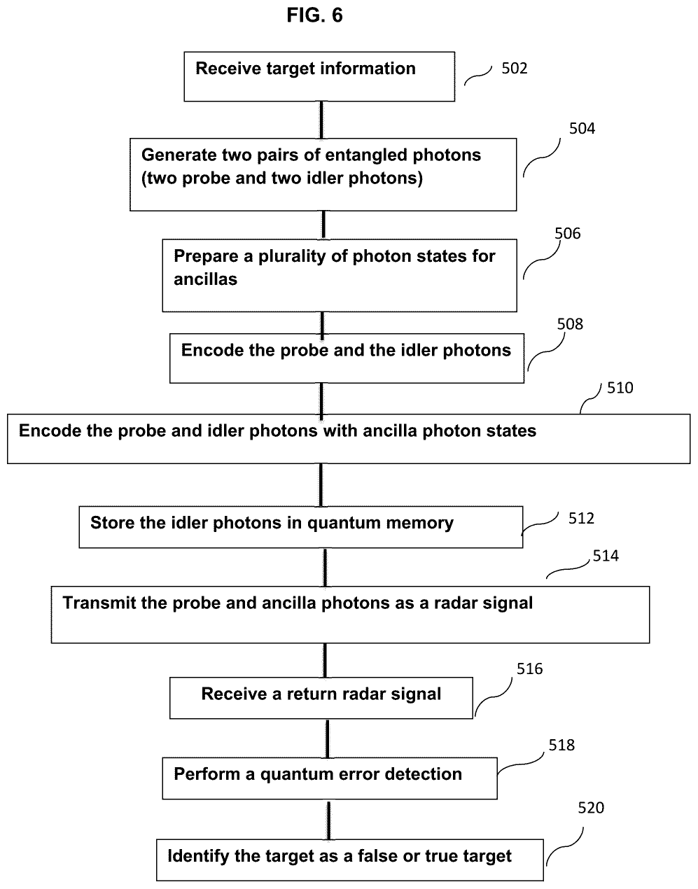

FIG. 6 illustrates a simplified process flow for quantum signal processor, according to some embodiments of the disclosure. As shown in block 502, target information, such as location, orientation, velocity, trajectory, and the signal structure data, processed by a classical radar/sensor is sent to (i.e., cues) a quantum radar/sensor. In block 504, pairs of entangled probe and idler photons are, for example, by one or more pump beams. In block 506, a plurality of photon states is prepared for ancilla photon states for each of the probe and idler photons. For example, for a four-wave mixing process, two pump beams (angularly separated) generate two pairs of entangled photons to prepare two signal probe photons and two idler photons. The first probe photon Is entangled with the first idler photon and the second probe photon is entangled with the second idler photon. The pump beams also supply prepared state ancilla photons; two for the signal probe photons and two for the idler photons.

In block 508, the probe photons and the idler photons are encoded using the ancilla photon states. In some embodiments, the probe photons are entangled with the probe ancilla photons using CNOT gates to create an encoded probe signal and the idler photons are entangled with the idler ancilla photons using CNOT gates to create an encoded idler state. In block 510, the probe photon and ancilla photon states are encoded to produce a transmit radar signal. The idler photons encoded with the ancilla photon states are then stored in a quantum storage device, such as a quantum memory in block 512.

In block 514, the encoded transmit radar signal is transmitted towards a target, using the received target information. For example, using a controller cued by a companion conventional radar, the encoded transmit radar signal is transmitted in the direction of the target, using the received target information. In block 516, a return radar signal is received from the target. The received radar signal includes the probe photons and the ancilla photon states for the probe photons. In block 518, a quantum error detection is performed on the received radar signal to determine whether there is an error in the received radar signal as a result of (e.g., loss of) decoherence in the return signal.

In some embodiments, at a time given by a controller (based on the cued range information to the target), the received radar signal including the probe photons and the ancilla photon states for the probe photons is passed to a decoder which uses quantum error detection methods (e.g., stabilizers and syndrome extraction) to determine any errors (bit-flip or phase-flip) received and the photon stream is passed to a correlator.

At the same time, the corresponding idler photons are decoded, for example, using a quantum error correction method. The correlator may be an analog device (e.g., a beam splitter) or a digital device that compares the probe photon stream with the idler photon stream and generates an error indicated by a correlation value. If the error/correlation value exceeds a threshold, the existence of a true target is confirmed, and if the error/correlation value does not exceed the threshold, the presence of a true target is not confirmed, that is the target is a false target, as shown in block 520. In some embodiments, the correlation search continues until a threshold time is reached and a true target Is determined.

In some embodiments, the error/correlation values are evaluated to determine decoherence. A degree of entanglement measure is computed based on the number and distribution of errors. If the error/correlation value (entanglement measure) exceeds a threshold, a real target is indicated (low decoherence). If the entanglement measure is less than the threshold, a false target is indicated (high decoherence).

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims and drawings.

1. A method for false radar target detection, the method comprising:
receiving target information from a target detection source;
generating pairs of entangled probe and idler photons;
preparing a plurality of photon states to generate ancilla photon states for each of the probe photon pair and the idler photon pair;
using the ancilla photon states to encode the probe photons and the idler photons;
encoding the probe photons and the idler photons with the ancilla photon state;
storing the idler photons;
transmitting the probe and ancilla photons as a radar signal towards a target, using the received target information;
receiving a return radar signal from the target, wherein the received radar signal includes the probe photons and the ancilla photon states for the probe photons;
performing a quantum error detection on the return radar signal to determine whether there is an error in the received radar signal as a result of decoherence in the return signal; and
correlating the probe signal and idler states and detecting the errors in the return radar signal to indicate the target as a false target when there is high decoherence in the return radar signal, or to indicate the target as a true target when there is low decoherence in the return radar signal.

2. The method of claim 1, wherein performing a quantum error detection determines the amount of decoherence in the return radar signal with respect to the stored idler photons.

3. The method of claim 2, further comprising comparing the decoherence in the return signal with a predetermined threshold, wherein decoherence greater than or equal to the predetermined threshold is associated with a false target and decoherence less than the predetermined threshold is associated with a true target.

4. The method of claim 1, wherein the transmit radar signal is an optical or pulsed microwave signal.

5. The method of claim 1, further comprising evaluating the error to determine decoherence in the received radar signal; computing a degree of entanglement measure based on the number and distribution of the errors; and determining that the target is a true target when the error exceeds a threshold.

6. The method of claim 5, wherein the error is an entanglement measure.

7. The method of claim 1, wherein the quantum error detection performed on the received radar signal is performed at a time determined based on range to the target received from the target detection source.

8. The method of claim 1, wherein the target information includes one or more of location, orientation, velocity, trajectory, and the signal structure data of the target.

9. The method of claim 1, wherein the quantum error detection is performed using stabilizers and syndrome extraction to determine the error.

10. The method of claim 9, wherein the error is a bit-flip or a phase-flip.

11. A quantum sensor comprising:
a transmitter including:
one or more photon sources for generating pairs of entangled photons as probe photons and idler photons,
a photon state preparer for preparing a plurality of photon states to generate an ancilla photon state for each of the probe photon pair and the idler photon pair,
a photon encoder for encoding the probe photons and the idler photons and encoding the probe photons and the idler photons with the ancilla photon states, and
an energy storage device for storing the idler photons, wherein the transmitter transmits the probe and ancilla photons as a radar signal towards a target; and
a receiver including:
a photon receiver for receiving a return radar signal from the target and detecting the entangled probe photons that are entangled with the ancilla states of the probe photons in the return signal, wherein the received radar signal includes the probe photons and the ancilla photon states for the probe photons, and
a quantum signal processor for performing a quantum error detection on the received radar signal to determine whether there is an error in the received radar signal, wherein a processor correlates the probe signal, the idler states and the errors detected on the return radar signal to indicate the target as a false target when there is high decoherence in the return radar signal, or to indicate the target as a true target when there is low decoherence in the return radar signal.

12. The quantum sensor of claim 11, wherein the photon source is a laser pump and a non-linear crystal.

13. The quantum sensor of claim 11, wherein the photon state preparer eliminates mixed states or forces the states of the photon to a predetermined set.

14. The quantum sensor of claim 13, wherein the photon state preparer is a polarizer for intercepting a portion of a pump beam from the photon source.

15. The quantum sensor of claim 11, wherein the energy storage device is a quantum memory.

16. The quantum sensor of claim 11, wherein the photon receiver is a phase-conjugate receiver or a spontaneous parametric down-converter.

17. The quantum sensor of claim 11, wherein the quantum signal processor determines the loss of decoherence in the return radar signal with respect to the stored idler photon.

18. The quantum sensor of claim 11, wherein the processor evaluates the error to determine decoherence in the received radar signal; computing a degree of entanglement measure based on the number and distribution of the errors; and determines that the target is a false target when the error exceeds a threshold.

19. The quantum sensor of claim 18, wherein the error is an entanglement measure.
